(19) United States
(12) Patent Application Publication
(10) Pub. No.: US 2004/0231306 A1
(43) Pub. Date: Nov. 25, 2004

(54) Exhaust gas particulate filter made of sintered metal

(76) Inventors: Peter Neumann, Menden (DE); Joachim-Christian Claus, Oelde (DE); Carsten Jutka, Menden (DE); Jochen Koll, Arnsberg (DE); Hans-Peter Frisse, Herzogenrath (DE)

Correspondence Address: RICK MARTIN, PATENT LAW OFFICES OF RICK MARTIN, PC, 416 COFFMAN STREET, LONGMONT, CO, 80501, US

(21) Appl. No.: 10/481,368

(22) PCT Filed: May 25, 2002
(86) PCT No.: PCT/EP02/05763

(30) Foreign Application Priority Data
Jun. 18, 2001 (DE) 101 28 936.7
Jun. 18, 2001 (DE) 101 28 937.5

(51) Int. Cl. B01D 39/06

(52) U.S. Cl. 55/523

(57) ABSTRACT

The invention relates to an exhaust gas particulate filter made of sintered metal for removing particulates contained in the exhaust gas stream of an internal combustion engine, particularly of a diesel internal combustion engine. The exhaust gas particulate filter is made of a filter material having at least one metal support (1), which has openings (O) and on which porous sintered metal powered is bound by means of a sintering process. The invention is characterized in that the support (1) consists of an expanded metal, and the sections delimitating the openings (O) of the support (1) are joined to one anther with a material bond. The support (1) had been calendered after the process of expanding it by an amount that does not exceed 70%

### CROSS REFERENCE APPLICATIONS

This application is a national phase application claiming priority from PCT application no. PCT/EP02/05763 filed on 25 May 2002 and claiming priority from German application 101 28 937.7 filed on 18 Jun. 2001 and from German application 101 28 937.5 filed on 18 Jun. 2001.

### FIELD OF INVENTION

The present invention relates to an exhaust gas particulate filter for the elimination of particulates contained in the exhaust gas stream of an internal combustion engine, in particular a diesel engine. The particulate filter is made of metal with at least one metal support including openings to which porous sinter metal is bound in a sintering process.

### BACKGROUND OF THE INVENTION

Sintered metal filters are employed as exhaust gas particulate filters for internal combustion engines, for example for diesel internal combustion engines, to eliminate particulates, such soot particles, contained in the exhaust gas stream. The exhaust gas particulate filters are mounted in the exhaust gas train of the engine and must be capable of withstanding the temperatures of the exhaust gas flowing through the exhaust gas particulate filters and also the temperatures generated during a soot burn-off for regenerating such an exhaust gas filter. Sintered metal filters fulfill these requirements. The sintered metal filters are produced by shaping filter material strips to form filter plates or filter pockets from which the filter body is fabricated.

The prior art filter strips are often made with a wire fabric as a support material. The wire fabric is coated with a sinter metal powder and then subjected to a sintering process. With this process sintered metal plates can be produced which have a porosity of approximately 50% to 80%. To form the filter body proper it is necessary to connect the individual reshaped filter plates or filter pockets together, by welding or other methods.

Such a sintered metal filter, in which a wire fabric is utilized as a support, is described in EP 0 505 832 B1. To improve the heat distribution, in particular the heat dissipation during welding of the sintered metal material, twill wire fabric serves as a support. Compared to otherwise customary wire fabrics, a twill wire fabric is distinguished in that in order to increase the contact points of the individual wires among themselves additional wires are woven into the fabric, of which one weft wire bridges several warp wires. Compared to other wire fabrics, with the twill fabric the heat transfer between individual wires is improved by increasing the heat transfer sites through the increased number of contact points between the individual wires. However, its rigidity and its weight also increase due to the additional wires for forming the fabric. This, in turn, has a disadvantageous effect on the necessary reshaping process required for producing filter plates or filter pockets. Higher reshaping forces are required compared to such filter material sections produced with other fabrics as the support material. It may therefore occur that the sinter material applied onto the twill wire fabric is damaged or even spalls off, due to the fact that its strength properties are reduced through the porosity relative to the support material and the necessary forces which must be made available for carrying out the reshaping process.

DE 195 20 146 C1 describes a method for the production of porous bodies, for example of exhaust gas particulate filters. In a first step a support material is reshaped before it is coated by flame spraying until the openings in the support material have become obstructed. Consequently, this document teaches to shape first the support material of the filter plate or of the filter pocket into its appropriate shape and then to coat this shaped body with the filter material proper. Apart from the fact that this method is unsuitable for producing sintered metal filters, using this method for the production of sintered metal filters would at best yield the advantage that during the reshaping, compared to other methods, the sinter metal layer applied on the support and the welding to produce the filter body of individual previously reshaped parts would be avoided.

However, exhaust gas particulate filters with filter chambers or filter pockets, which only have an opening width of a few millimeters or—formed as a wedge filter—even taper, cannot be produced with the method described in this publication. Moreover, the danger exists that the connection between the support and the applied material is also damaged due to the large temperature fluctuations at exhaust gas and regeneration temperatures compared to the temperatures when not in operation.

EP 0 166 606 B1 discloses a porous metal object, which can be employed as a filter. In this porous object a metal support with openings serves as a support for the sinter metal powder introduced into the openings. During the process of sintering the metal power becomes caked with itself and with the support. As a support for forming this filter material, supports of metal with openings, regardless of their properties, have been described, and in this document expanded metal as a support equivalent to a support of an otherwise customarily utilized wire fabric is also mentioned. Subject matter of this document is the filling of the openings of the support with a suitable metal powder in order to provide in this manner a metal filter with which fine-grained particles can also be removed from a mass flow. However, this document does not disclose that it could be useful to utilize a filter body produced according to the method described in this document as a sintered metal filter for eliminating particulates contained in the exhaust gas stream of an internal combustion engine. This document consequently also does not disclose any references to the manner in which such sintered metal filters could be formed appropriately.

Building on the previously discussed prior art, the invention therefore addresses the problem of further developing a sintered metal filter such that the filter material employed for structuring the sintered metal filter for providing different sintered metal filter bodies is not only reshapable quasi like a solid material but also can be welded more easily.

This problem is solved according to the present invention wherein the support 1 is an expanded metal and consequently the segments bounding the openings O of the support 1 are materially connected with one another and the support 1 has been calendered after the process of expansion by a degree not exceeding 70%.

In the disclosed sintered metal filter the support comprises a material forming a material unit, namely an expanded metal. Providing an expanded metal as the support, due to its material unity has the advantage that the heat distribution within the filter, and consequently the heat dissipation during welding, and also during the regeneration of the sintered metal filter, is improved, since, in contrast to the published prior art heat transfers for the necessary heat transport within the support are avoided due to the material unity. The formation of the support's expanded metal has further advantages during reshaping, in particular if stamping to form reinforcing creases or the like are to be produced. In contrast to published prior art, due to the material unity in such sintered metal element there is little risk that during to the reshaping process individual wires of a fabric are displaced with respect to one another. This could cause spalling off or spalling out of sintered metal. Consequently, this support material is highly dimensionally stable, especially during the reshaping process. Without sacrificing the heat distribution or heat dissipation, the support for the sintered material can have a relatively large opening width, which favorably affects the exhaust back pressure, since the areal component of the support material can be reduced on the filter surface.

After the expansion process the expanded metal is calendered and specifically by no more than 70%. This ensures that even after the calendering process, the webs of the expanded metal provide for the encompassed openings a sufficient abutment area, so that sintered metal included in the openings is held form-locked in them. In particular, in order to meet the requirements during the specified application of the sintered metal filter.

The ratio of weight of the support and sintered metal taking part in the structuring of the filter material is usefully less than 3:7 of support:sintered metal. This ratio is preferably between 2:8 and 1:9, and with these ratio specifications it is assumed that sintered metal powder is only in the openings of the support. However, if very high requirements are made of the stability of the exhaust gas particulate filter, it is entirely possible for a ratio of approximately 1:1 to be utilized. The formation of a filter material with such a small support material component is not realizable with conventional supports of fabrics, at least not with the strength obtained with the filter material according to the invention.

An expanded metal is preferably utilized as the support material. One advantage of expanded metal as the support material is that it has an especially good uniform dimensional stability in different directions as well as being simple and cost-effective to produce. Of special advantage when using an expanded metal as a support is that by the integral upper and lower closure of the individual regions defining an opening, the sintered material does not need to form a continuously statically effective layer on the support. Rather the sintered material only needs to be introduced into the opening of the support. This not only reduces the quantity of the required sinter material, but it has the advantage that essentially during the reshaping the webs of the expanded metal located between the openings are reshaped and not or only secondarily the sintered material introduced into the opening. Therefore reshaping steps, such as for example a turning on edge by 90□ or also by 180□ can be carried out without the danger that the sintered material introduced into the openings breaks out. Such turning on edge may be required to reinforce the margin region of a filter plate or also to be able to form a material thickening for the subsequent welding.

When providing a support of expanded metal it is an advantage that through the expanding process the openings necessary for forming mesh-form structures can have different dimensioning. This can be attained through the degree of expansion and/or by introducing different incisions before the expansion process proper. In this way elements for a sintered metal filter can be provided, which have a different opening geometry as a function of their disposition within the sintered metal filter body.

When using an expanded metal as the support it is possible to specify through the degree of expansion the slope of the webs for holding the sintered metal fillings, apart from the opening width of the openings of the support. The thickness can also be adjusted via the step of calendering. Consequently one and the same starting material can be used in to produce filter material strips of different formation. The thickness of such a filter material strip is determined by the degree of elevation of the webs of the support bounding the openings, so that filter material strips can be produced which have a thicker gauge, without the support material component of the total weight of the filter material strip increasing excessively This is in contrast to fabrics in which the thickness is determined by the thickness of the wire employed.

### SUMMARY OF THE INVENTION

The primary aspect of the present invention is to provide a sintered metal particulate filter for internal combustion engines.

Other aspects of this invention will appear from the following description and appended claims, reference being made to the accompanying drawings forming a part of this specification wherein like reference characters designate corresponding parts in the several views.

### BRIEF DESCRIPTION OF THE DRAWINGS

FIG. 1 is a schematic representation of a section of: a support of a filter material for the formation of a sintered metal filter.

FIG. 2 is a schematic section along line A-B through an enlarged section of the support of FIG. 1, whose openings are filled with sintered metal powder.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

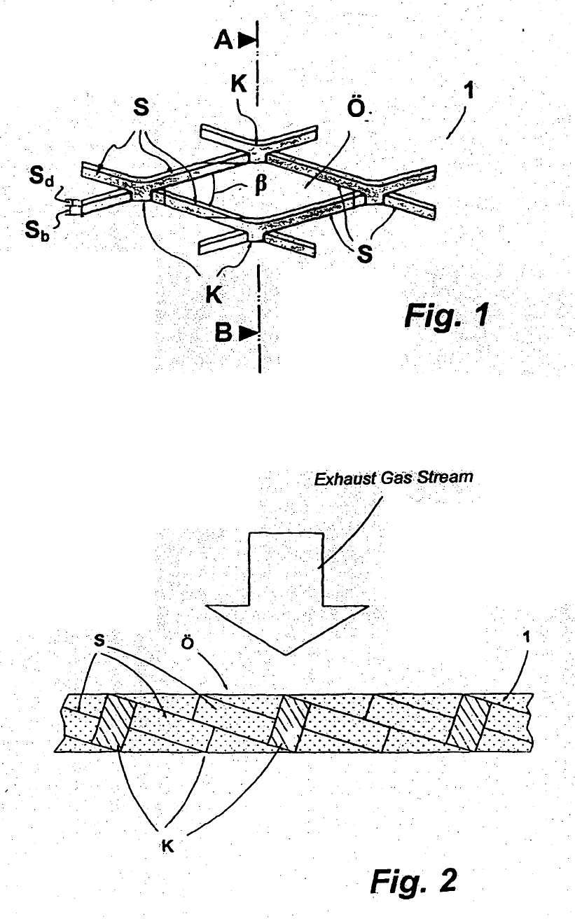

FIG. 1 shows a support 1 for forming filter material for a sintered metal filter to eliminate particulates contained in the exhaust gas stream of a diesel internal combustion engine produced of expanded metal. The support 1 is made from a steel sheet as the starting material. Incisions are introduced into the sheet for producing the openings by way of the expansion process. In the course of an expansion process the steel sheet has been brought into the form shown in FIG. 1, and the incisions originally introduced into the steel sheet have widened to form openings O. The openings O are bounded by segments denoted as segments S of the original steel sheet, which join in those regions of the support in which the incisions terminate. These regions are denoted as node points K. All segments S of support 1 are consequently in material connection via the node points K. This permits the formation of a support which not only ensures an especially good heat dissipation and heat distribution, but which also is able to show a very high stability which is uniform in different directions.

The opening angle β between two segments S separated by an incision is usefully in the range between 40° and 80°, preferably between 50° and 70°. At smaller opening angles the opening is so small that the filter material would offer too high an exhaust gas back pressure.

The structure of support 1 is evident at an enlarged scale in the cross section of FIG. 2. The depicted section line intersects several node points K, from which one segment S each extends to the next node point K. The segments S themselves, as shown by node point K, are tilted and form openings O with inclined side faces. These inclined side faces permit an especially good bracing of the sintered metal introduced therein, as is indicated in FIG. 2. Each opening O is filled with sintered metal, and the cross section depicted in FIG. 2 shows that the sintered metal fillings are each held form-locked in an opening O provided by support 1. Consequently the support 1 with its openings O offers good mechanical bracing properties and an effective abutment, such that there is no danger that the sinter material introduced into the openings is pressed out of the individual openings, in spite of the pressure difference between the up-stream filter side and the down-stream side filter side. The sintered metal fillings are consequently insular aggregates, each received in the openings O of support 1.

The gauge of the original steel sheet for forming the support 1 corresponds to the narrow side of a node point K between the segment thickness S_{d}. The ratio of segment width S_{b} to segment thickness S_{d} is usefully 1. At such a ratio the segments are square on cross section. To be able to attain adequate form-locking with the sintered metal, the segments can also have segment width to segment thickness ratios between 0.5 and 2.0.

The proximal mechanical connection of the segments S and node points K participating in the structure of support 1 make clear that the support 1 is capable of withstanding high mechanical stresses. Since support 1 forms a material unit and is more readily deformable relative to the sintered metal, a reshaping takes place primarily at the segments S and the node points K in the event that the filter material is reshaped for example by turning on edge or by embossing reinforcing creases.

To improve the bonding properties between the sinter metal powder during the sintering and the support, it is advisable to provide the surface of the support 1 with texturing, for example a microtexturing, produced by chemical treatment or a jet process involving particles. Through such a jet process moreover a certain intrinsic tension can be built into the support (tension beams) which has a favorable effect on its strength. With such a measure the effective surface of the support is increased, especially in the side faces directed toward one another, of the segments S bounding the openings O, such that a bracing of the sintered metal powder on the segments S of the support 1 is possible.

The grain fraction or particle size of the sinter metal powder employed is dimensioned such that at least 10 layers of powder should be provided in order to fill out an opening O of support 1 in the direction of the gauge of support 1. However, for the formation of sintered metal filters to eliminate the particulates contained in the exhaust gas stream of an internal combustion engine, it has been found to be sufficient to fill the openings O of support 1 with sinter metal powder of a grain size such that maximally 15 powder layers are provided in the direction of the thickness of the filter material formed therefrom.

As the starting material a steel sheet having a gauge of 0.2 mm can be used. Depending on the configuration and disposition of the incisions, after carrying out the expansion process, the thickness of the support formed therefrom can be 3 mm. It should be noted that regardless of the thickness during the expansion process, the support weight does not increase. If required, the expanded material can be calandered, for example to a thickness of. 0.9 mm, which corresponds to a calandering of 70%.

Although the present invention has been described with reference to the disclosed embodiments, numerous modifications and variations can be made and still the result will come within the scope of the invention. No limitation with respect to the specific embodiments disclosed herein is intended or should be inferred. Each apparatus embodiment described herein has numerous equivalents.

### List of Reference Symbols

1 Support

K Node point

O Opening

S Segment

S_{b} Segment width

S_{d} Segment thickness

β Opening angle

1-11. Cancelled

12. An exhaust gas particulate filter of sintered metal for eliminating particulates contained in the exhaust gas stream of an internal combustion engine comprising;
a filter material of metal with at least one support having openings bounded by segments;
porous sintered metal powder sintered on to the filter material
the support formed from an expanded metal, the process of expansion not exceeding 70%, thereby the segments bounding the openings of support are materially connected with one another and the support; and
the support being calendered after the expansion process.

13. The exhaust gas particulate filter as claimed in claim 12, wherein the support has not been calendered by more than 50%.

14. The exhaust gas particulate filter as claimed in claim 12 or 13, wherein the ratio of weight of the support to that of the sintered metal is less than 3:7 relative to the total weight of the filter material.

15. Exhaust gas particulate filter as claimed in claim 14, wherein the ratio of weight of the support to that of the sintered metal is between 2:8 and 1:9 relative to the total weight of the filter material.

16. Exhaust gas particulate filter as claimed in one of claims 12 to 13, wherein the sintered metal essentially only fills out the openings of support.

17. Exhaust gas particulate filter as claimed claim 14, wherein the sintered metal essentially only fills out the openings of support.

18. The exhaust gas particulate filter as claimed in one of claims 12 or 13, wherein the exhaust gas particulate filter is comprised of more than one elements of the filter material whose margin segments to be connected are reshaped by at least one turning-on-edge processes.

19. The exhaust gas particulate filter as claimed in claim 14, wherein the exhaust gas particulate filter is comprised of more than one elements of the filter material whose margin segments to be connected are reshaped by at least one turning-on-edge processes.

20. The exhaust gas particulate filter as claimed in claim 15, wherein the exhaust gas particulate filter is comprised of more than one elements of the filter material whose margin segments to be connected are reshaped by at least one turning-on-edge processes.

21. The exhaust gas particulate filter as claimed in claim 16, wherein the exhaust gas particulate filter is comprised of more than one elements of the filter material whose margin segments to be connected are reshaped by at least one turning-on-edge processes.

22. The exhaust gas particulate filter as claimed in claim 17, wherein the exhaust gas particulate filter is comprised of more than one elements of the filter material whose margin segments to be connected are reshaped by at least one turning-on-edge processes.

23. Exhaust gas particulate filter as claimed in one of claims 18 wherein the elements of the exhaust gas particulate filter are stamped by a stamping process, for example for the formation of reinforcing creases or reinforcing elements.

24. Exhaust gas particulate filter as claimed in one of claims 19 wherein the elements of the exhaust gas particulate filter are stamped by a stamping process, for example for the formation of reinforcing creases or reinforcing elements.

25. Exhaust gas particulate filter as claimed in one of claims 20 wherein the elements of the exhaust gas particulate filter are stamped by a stamping process, for example for the formation of reinforcing creases or reinforcing elements.

26. Exhaust gas particulate filter as claimed in one of claims 21 wherein the elements of the exhaust gas particulate filter are stamped by a stamping process, for example for the formation of reinforcing creases or reinforcing elements.

27. Exhaust gas particulate filter as claimed in one of claims 22 wherein the elements of the exhaust gas particulate filter are stamped by a stamping process, for example for the formation of reinforcing creases or reinforcing elements.

28. Exhaust gas particulate filter as claimed in one of claims 12 to 13, wherein a powder fraction of the employed sinter metal powder is laid out such that, in adaptation to a particular thickness of the support, at least 10 powder layers are provided in one opening.

29. Exhaust gas particulate filter as claimed in claim 16, wherein a powder fraction of the employed sinter metal powder is laid out such that, in adaptation to a particular thickness of the support, at least 10 powder layers are provided in one opening.

30. Exhaust gas particulate filter as claimed claim 18, wherein a powder fraction of the employed sinter metal powder is laid out such that, in adaptation to a particular thickness of the support, at least 10 powder layers are provided in one opening.

31. Exhaust gas particulate filter as claimed claim 23, wherein a powder fraction of the employed sinter metal powder is laid out such that, in adaptation to a particular thickness of the support, at least 10 powder layers are provided in one opening.

32. Exhaust gas particulate filter as claimed in one of claims 12 to 13, wherein an opening angle of the opening of the support is between 40° and 80°.

33. Exhaust gas particulate filter as claimed in one of claims 12 to 13, wherein the ratio between segment width (S_{b}) and segment thickness (S_{d}) of the support is between 0.5 and 2.0.

34. Exhaust gas particulate filter as claimed in one of claims 12 to 13, wherein the ratio between segment width (S_{b}) and segment thickness (S_{d}) of the support is approximately 1.0.

35. Exhaust gas particulate filter as claimed in one of claims 12 to 13, wherein the surface of the support is textured, in particular microtextured, to improve the bracing between the sintered metal and the support.
